(19) United States
(12) Patent Application Publication
(10) Pub. No.: US 2005/0174978 A1
(43) Pub. Date: Aug. 11, 2005

(54) Guard codes for S-CDMA systems

(76) Inventors: Ofir Shalvi, Herzlia (IL); Itay Sherman, Raanana (IL); Ariel Yagil, Ramat Hasharon (IL)

Correspondence Address: TEXAS INSTRUMENTS INCORPORATED, P O BOX 655474, M/S 3999, DALLAS, TX, 75265, US

(21) Appl. No.: 10/828,807

(22) Filed: Apr. 20, 2004

Related U.S. Application Data
(63) Continuation of application No. 09/481,317, filed on Jan. 11, 2000, now abandoned.
(60) Provisional application No. 60/115,514, filed on Jan. 11, 1999.

(51) Int. Cl. H04B 7/216

(52) U.S. Cl. 370/342

(57) ABSTRACT

A method is provided for reduced interference between S/CDMA channels (chips) by selecting a first sequence of spreader functions for a first channel, and selecting a second sequence of spreader functions for a second channel, wherein said second sequence is non-overlapping with and spaced from first said sequence.

This application claims priority under 35 USC § 119(e)(1) of Provisional Application Ser. No. 60/115,514, filed Jan. 11, 1999.

### TECHNICAL FIELD OF THE INVENTION

The present invention relates to a common Synchronous-CDMA (S-CDMA) system.

### BACKGROUND OF THE INVENTION

In S-CDMA systems a high level of synchronization between transmitting sources is required, in order to avoid interference between different codes. This requirement imposes high cost and risk to S-CDMA systems.

### SUMMARY OF THE INVENTION

The present invention provides a method for relaxing the timing accuracy requirements in Synchronous Code Division Multiple Access (S-CDMA) systems. The relaxation is done by keeping some of the spreading codes as “guard codes”, i.e., not using some of the codes. In this way, interference due to timing error may be decreased. This invention allows for a relaxation of the synchronization requirements at the cost of small decrease in the data throughput of the system, thus decreasing the cost and risk of S-CDMA systems.

### BRIEF DESCRIPTION OF THE DRAWINGS

For a more complete understanding of the present invention, and the advantages thereof, reference is now made to the following detailed description taken in conjunction with the accompanying drawings, in which:

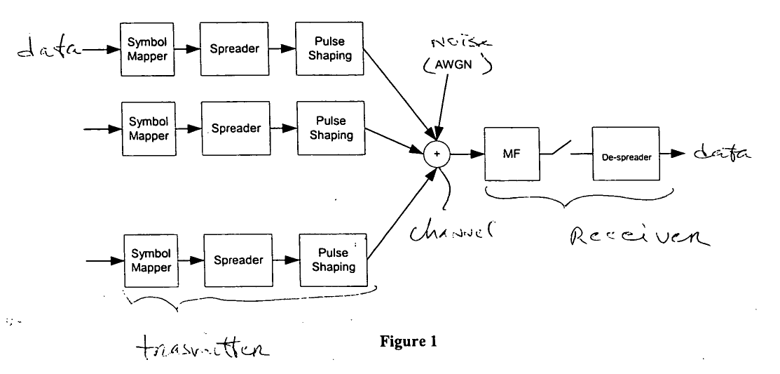

A common Synchronous-CDMA (S-CDMA) system is shown in FIG. 1.

### DETAILED DESCRIPTION

A common Synchronous-CDMA (S-CDMA) system is shown in FIG. 1. In this system N data symbols are transmitted at the same time from up to N different synchronized sources (each source can transmit one or more data symbols at a given time). Each of these symbols is multiplied by a different spreading code (consisting of N bits). The sequences of the spread symbols are summed (resulting in N “chips”):
p=s^{T}·C

where s is the vector of the N transmitted symbols, C is the matrix of spreading codes (each row in C is a spreading code), and p is the sequence of then N transmitted chips.

The N spreading codes are orthogonal: C·C^{T}=I.

In some S-CDMA systems there is one basic code C₀ and all the other codes are generated by cyclically shifting the basic code: Cᵢ[n]=C₀[(n+i)mod N], n=0 . . . N−1

The invention is also applicable in cases where the spreading codes are not exactly shifted versions of the basic code, but are highly correlated with the shifted versions. It is also applicable when a few (n<<N) codes are not shifted versions of the basic code at all.

After spreading, the chips are fed into a pulse-shaping filter and transmitted to the channel. In the receiver, the signal is fed into a matched filter and sampled. It is assumed that the convolution of transmitter's shaping filter with the receiver's matched filter is a Nyquist-I filter (e.g. raised-cosine), i.e. there is no inter-symbol interference between the chips (when the sources are synchronized). If we assume that all the transmitting sources are perfectly synchronized, (i.e. the symbol timing at the receiver is identical for all the sources), then the sequence at the matched filter output is p (plus channel noise). Multiplying the matched filter output by the transpose of the spreading matrix would recover the transmitted symbols. This operation is called despreading:
Ŝ=(p+n)·C^{T}=s·C·C^{T}+ñ=s+ñ

However, this behavior is achieved only when the transmitting sources are fully synchronized. In real (non-ideal) systems, full synchronization cannot be achieved. In this case there will be some degree of interference between symbols that are transmitted from different sources. It can be shown that the recovered symbol sequence will be as follows (for the case of two transmitting sources):

$$\hat{\underline{s}} = M \underline{s} + \tilde{\underline{n}}$$

$$M = [ \begin{matrix}1 & & & & & ⋰ & & & & & & \\ & ⋰ & & ( 0 ) & & {R}_{4} & ⋰ & & & & & \\ & & 1 & & & {R}_{3} & ⋰ & ⋰ & & & & \\ & & & 1 & & {R}_{2} & {R}_{3} & ⋰ & ⋰ & & & \\ & ( 0 ) & & & 1 & {R}_{1} & {R}_{2} & {R}_{3} & {R}_{4} & ⋰ & & \\ ⋰ & {R}_{- 4} & {R}_{- 3} & {R}_{- 2} & {R}_{- 1} & {R}_{0} & & & & & & \\ & ⋰ & ⋰ & {R}_{- 3} & {R}_{- 2} & & {R}_{0} & & & & ( 0 ) & \\ & & ⋰ & ⋰ & {R}_{- 3} & & & {R}_{0} & & & & \\ & & & ⋰ & {R}_{- 4} & & & & {R}_{0} & & & \\ & & & & ⋰ & & ( 0 ) & & & ⋰ & & \\ & & & & & & & & & & ⋰ & \\ & & & & & & & & & & & {R}_{0}\end{matrix} ]$$

$${R}_{n} = g ( t - nT - τ )$$

where g is the Nyquist-I pulse shape (e.g. raised cosine) and τ is the timing difference between the two sources.

It can be seen from the equations that the symbols of each source are interfered by the symbols of the other source. The most significant interference comes from the terms R₁ and R₋₁. These terms are the interference between two symbols that are spread by “adjacent” codes (codes with adjacent indices). Therefore, a significant decrease in the interference can be achieved if adjacent codes are not allocated to different sources. This can be achieved by allocating to each source a block of codes with consecutive indices, leaving one “guard” code between these blocks. For example, if N=128 and there are two sources, one source would use codes 0 to 45, and the second source would use codes 47 to 126. Codes 46 and 127 would not be used.

This method allows a significant relaxation of the timing requirements of the transmitting sources, at a cost of slight decrease in the data throughput (less than 2% in the above two source examples).

1. A method for providing reduced interference between S/CDMA channels (chips), comprising;
selecting a first sequence of spreader functions for a first channel, and
selecting a second sequence of spreader functions for a second channel, wherein said second sequence is non-overlapping with and spaced from first said sequence.
